(19) United States
(12) Patent Application Publication
(10) Pub. No.: US 2026/0048387 A1
(43) Pub. Date: Feb. 19, 2026

(54) HYDROCRACKING CATALYST COMPRISING HIERARCHICAL ZEOLITE Y AND MESOPOROUS NANO-SIZED ZEOLITE BETA COMPOSITE

(71) Applicant: Saudi Arabian Oil Company, Dhahran (SA)

(72) Inventors: Lianhui Ding, Dhahran (SA); Faisal Alotaibi, Al-Khobar (SA); Mazin Tamimi, Khobar (SA); Mohammad Aljishi, Qatif (SA); Batool Altaher, Dhahran (SA); Eman Albaher, Qatif (SA)

(73) Assignee: Saudi Arabian Oil Company, Dhahran (SA)

(21) Appl. No.: 18/804,970

(22) Filed: Aug. 14, 2024

(51) Int. Cl. B01J 29/80; B01J 21/04; B01J 29/14; B01J 29/16; B01J 29/76; B01J 29/78; B01J 35/61; B01J 35/63; B01J 35/64; B01J 37/00; B01J 37/04; B01J 37/06; B01J 37/08; C10G 11/05

(52) U.S. Cl. CPC B01J 29/80; B01J 21/04; B01J 29/146; B01J 29/166; B01J 29/7615; B01J 29/7815; B01J 35/615; B01J 35/633; B01J 35/635; B01J 35/647; B01J 37/0018; B01J 37/04; B01J 37/06; B01J 37/08; C10G 11/05; B01J 2229/20; C10G 2400/20

(57) ABSTRACT

A catalyst comprising a zeolite beta and a hierarchical zeolite Y. The zeolite beta comprises a plurality of micropores having a pore size of less than 2 nm and a plurality of mesopores having a pores size of greater than or equal to 2 nm to less than or equal to 50 nm. A volume of mesopores is greater than or equal to 35% of a total pore volume of the zeolite beta and an average particle size of the zeolite beta is less than or equal to 100 nm.

### TECHNICAL FIELD

Embodiments disclosed herein generally relate to chemical processing and, more specifically, to a catalyst and methods for producing and using the catalysts.

### BACKGROUND

The processing of crude oil into more valuable petroleum products may begin with catalytic cracking or hydrocracking. Catalytic cracking converts heavier fractions of crude oil into lighter, more valuable products. Hydrocracking is a process of combining catalytic cracking and hydrogenation, wherein heavier feedstocks are cracked in the presence of hydrogen to produce more desirable high-value products. These hydrocracking treatments require catalysts which can at least partially crack the large molecules present in the heavy oils. Many hydrocracking catalysts use a zeolite as a cracking components. Hydrocracking is a versatile catalytic process that converts heavy oils to lighter products by aromatic saturation, cracking, and isomerization reactions in the presence of hydrogen.

Conventional catalysts may have poor cracking conversion. Coke formation is a common problem when heavy fractions cannot be cracked effectively. Accordingly, new catalysts suitable for hydrocracking with various improved attributes are needed.

### BRIEF SUMMARY

There is a need for catalysts with, in some embodiments, improved mass transfer. Currently, conventional catalyst active sites are too small to allow large molecules of the heavy oil fraction to diffuse to and contact the active sites. The small pore size of the common zeolites used in conventional catalysts have difficulty cracking larger molecules in crude oil as a result of the inability of larger molecules of the crude oil to reach active sites. This leads to decreased activity of the catalysts and a possible deactivation of the catalysts. To accommodate larger molecules contacting active sites in a catalyst for hydrocracking, the inclusion of increased pore sizes to accommodate larger molecules is a desired property to consider for increased cracking conversion potential. Presently discovered, and included in embodiments described herein, are catalysts suitable for hydrocracking large molecules wherein when the catalyst utilized in the hydrocracking uses zeolites as cracking components, the zeolites with an increased volume of larger pores, conversion of heavy oil fractions is improved in hydrocracking crude oil.

According to one or more embodiments, the catalyst may comprise zeolite beta and hierarchical zeolite Y, wherein the zeolite beta may comprise a plurality of micropores having a pore size of less than 2 nm and a plurality of mesopores having a pore size of greater than or equal to 2 nm to less than or equal to 50 nm, a volume of mesopores greater than or equal to 35% of a total pore volume of the zeolite beta; and an average particle size of the zeolite beta may be less than or equal to 100 nm.

According to one or more embodiments, a method of making a catalyst may comprise forming a composite comprising hierarchical zeolite Y and zeolite beta, extruding the composite to form a plurality of extrudates, and heating the extrudates, wherein the zeolite beta may comprise a plurality of micropores having a pore size of less than 2 nm and a plurality of mesopores having a pore size of greater than or equal to 2 nm to less than or equal to 50 nm, a volume of mesopores may be greater than or equal to 35% of a total pore volume of the zeolite beta, and an average particle size of the zeolite beta may be less than or equal to 100 nm.

According to one or more embodiments, a process for upgrading a heavy oil where the process may comprise contacting the heavy oil with a catalyst, wherein the contacting hydrocracks the heavy oil to produce an updated product stream, the catalyst may comprise zeolite beta, and hierarchical zeolite Y, wherein the zeolite beta may comprise a plurality of micropores having a pore size of less than 2 nm and a plurality of mesopores having a pore size of greater than or equal to 2 nm to less than or equal to 50 nm, a volume of mesopores may be greater than or equal to 35% of a total pore volume of the zeolite beta, and an average particle size of the zeolite beta may be less than or equal to 100 nm.

This summary is provided to introduce a selection of concepts that are further described in the detailed description. This summary is not intended to identify key or essential features of the claimed subject matter, nor is it intended to be used as an aid in limiting the scope of the claimed subject matter.

Additional features and advantages of the described embodiments will be set forth in the detailed description that follows. The additional features and advantages of the described embodiments will be, in part, readily apparent to those skilled in the art from that description or recognized by practicing the described embodiments, including the detailed description that follows as well as the claims.

### DETAILED DESCRIPTION

Presently described, according to one or more embodiments, are catalysts, methods for producing catalysts, and methods for using catalysts. Catalyst described in this disclosure may comprise zeolite beta and hierarchical zeolite Y.

### Terms and Definitions

As used in this disclosure, a “catalyst” refers to any substance that increases the rate of a specific chemical reaction. Catalysts described in this disclosure may be utilized to promote various reactions, such as, but not limited to, cracking of a hydrocarbon feed stream.

As used throughout this disclosure, “zeolites” refer to micropore-containing inorganic materials with regular intra-crystalline cavities and channels of molecular dimension.

As used in the present disclosure, the term “crude oil” refers to a mixture of petroleum liquids and gases, including impurities, such as sulfur-containing compounds, nitrogen-containing compounds, and metal compounds, extracted directly from a subterranean formation or received from a desalting unit without having any fractions, such as naphtha, separated by distillation. In other embodiments, the crude oil may be processed, such as hydrotreated, and/or separated by distillation, and the hydrocarbon feed stream may comprise a processed stream of the crude oil.

As used in this disclosure, a “reactor” refers to a vessel in which one or more chemical reactions may occur between one or more reactants optionally in the presence of one or more catalysts. For example, a reactor may include a tank or tubular reactor configured to operate as a batch reactor, a continuous stirred-tank reactor (CSTR), or a plug flow reactor. Example reactors include packed bed reactors such as fixed bed reactors, and fluidized bed reactors. One or more “reaction zones” may be disposed in a reactor. As used in this disclosure, a “reaction zone” refers to an area where a particular reaction takes place in a reactor. For example, a packed bed reactor with multiple catalyst beds may have multiple reaction zones, where each reaction zone is defined by the area of each catalyst bed.

As used in this disclosure, “cracking” generally refers to a chemical reaction where carbon-carbon bonds are broken. For example, a molecule having carbon to carbon bonds is broken into more than one molecule by the breaking of one or more of the carbon to carbon bonds, or is converted from a compound which includes a cyclic moiety, such as a cycloalkane, cycloalkane, naphthalene, an aromatic or the like, to a compound which does not include a cyclic moiety or contains fewer cyclic moieties than prior to cracking.

As used throughout this disclosure, “micropore” refer to a pore in a structure that has a diameter of less than or equal to 2 nm and greater than or equal to 0.1 nm, and “mesopore” refers to a pore in a structure that has a diameter of greater than or equal to 2 nm and less than or equal to 50 nm.

Unless otherwise described herein, the “pore size” of a material refers to the average pore size, but materials may additionally include mesopores having a particular size that is not identical to the average pore size and thus contain a distribution of pores.

As used herein, “hydrothermally treating” may refer to heating a material in the presence of steam and less than 2% oxygen. In embodiments, the hydrothermal treatment may produce self-generated steam from water contained in the material. In other embodiments, additional moisture may be applied during the hydrothermal treatment.

As used herein, “calcining” may refer to heating a material to an elevated temperature, and holding the temperature of the material at an elevated temperature for a duration of time in an environment comprising at least 5 wt. % oxygen.

It should be understood that an “effluent” generally refers to a stream that exits a system component such as a separation unit, a reactor, or reaction zone, following a particular reaction or separation, and generally has a different composition (at least proportionally) than the stream that entered the separation unit, reactor, or reaction zone.

It should be understood that a “product effluent” generally refers to a stream that exits a system component such as a reactor or reactor zone, following a particular reaction, and generally has a different composition (at least proportionally) than the stream that entered the reactor or reaction zone, such as the hydrocarbon feed stream.

As used in this disclosure, “naphtha” refers to an intermediate mixture of hydrocarbon-containing materials derived from crude oil refining and having atmospheric boiling points from 25° C. to 180° C.

Presently described, according to one or more embodiments, are catalysts, methods for producing catalysts, and methods for using catalysts. Catalyst described in this disclosure may be utilized to promote various reactions, such as, but not limited to, cracking of a hydrocarbon feed stream.

Generally described in this disclosure are embodiments of zeolites, such as BEA framework type zeolites which include zeolite beta, and such as zeolite having an aluminosilicate FAU framework type which include hierarchical zeolite Y, that may be incorporated into hydrotreating catalysts. In some embodiments, the hydrotreating catalysts may be utilized to crack aromatics in heavy oils in a pretreatment process that may take place prior to steam cracking or other downstream processing. The present disclosure also relates to methods for producing such zeolites, as well as the properties and structure of the produced zeolites. According to one or more embodiments, a zeolite composition may comprise a relatively small particle size and may include mesoporosity. Such zeolite materials may be referred to throughout this disclosure as “nano-sized, mesoporous zeolites.” The microporous structure of zeolites (for example, 0.3 nm to 1 nm pore size) may render large surface areas and desirable size-/shape-selectivity, which may be advantageous for catalysis. The mesoporous zeolites described may include, for example, aluminosilicates, titanosilicates, or pure silicates. In one or more embodiments, the zeolites described may include micropores (present in the microstructure of a zeolite), and additionally include mesopores. The zeolites presently described may be characterized as beta (that is, having an aluminosilicate BEA framework type).

In embodiments, the zeolite beta and the hierarchical zeolite Y described may include micropores (present in the microstructure of the zeolite beta and the hierarchical zeolite Y), and additionally include mesopores. The average pore size may be determined from a nitrogen physisorption analysis. Further, the average pore size may be confirmed by transmission electron microscope (TEM) characterization. The high acidity and hydrothermal stability of zeolite beta make it a desirable catalyst component for use in, for example, hydrocracking, fluid catalytic cracking, hydrotreating, and isobutene alkylation.

Without intending to be bound by any particular theory, it is believed that the relatively large pore size (that is, the mesoporosity) of the presently described zeolites and catalysts that comprise the zeolites allows for larger molecules to diffuse inside the zeolite, which is believed to enhance the reaction activity and selectivity of the catalyst. With the increased pore size, aromatic containing molecules can more easily diffuse into the catalyst and aromatic cracking may be increased. For example, in some conventional embodiments, the feedstock converted by the catalysts may be vacuum gas oils, light cycle oils from, for example, a fluid catalytic cracking reactor, or coker gas oils from, for example, a coking unit. The molecular sizes in these oils are relatively small relative to those of heavy oils such as crude oil and atmosphere residue, which may be the feedstock of the present methods and systems. The heavy oils generally may not be able to diffuse inside the conventional zeolites and be converted on the active sites located inside the zeolites. Therefore, zeolites with larger pore sizes (that is, for example, mesoporous zeolites) may allow for the larger molecules of heavy oils to overcome the diffusion limitation, and may make possible reaction and conversion of the larger molecules of the heavy oils.

In embodiments, the zeolite beta may comprise a molar ratio of silica to alumina of from 5:1 to 500:1, such as from 5:1 to 400:1, from 5:1 to 300:1, from 5:1 to 200:1 or from 5:1 to 100:1.

In embodiments, the zeolite beta may have a particle size of from 30 nm to 100 nm, such as from 30 nm to 80 nm, 30 nm to 50 nm, 40 nm to 80 nm, and 40 nm to 50 nm.

In embodiments, the zeolite beta may have a surface area of greater than or equal to 400 cm²/g, such as greater than or equal to 450 cm²/g, or greater than or equal to 500 cm²/g. In embodiments, the zeolite beta may have a surface of from 400 cm²/g to 700 cm²/g, such as from 400 cm²/g to 600 cm²/g, from 400 cm²/g to 550 cm²/g, from 450 cm²/g to 700 cm²/g, from 450 cm²/g to 650 cm²/g, from 450 cm²/g to 600 cm²/g, from 450 cm²/g to 550 cm²/g, from 500 cm²/g to 700 cm²/g, from 500 cm²/g to 650 cm²/g, from 500 cm²/g to 600 cm²/g, or from 500 cm²/g to 550 cm²/g. The surface area is determined using BET analysis.

In embodiments, the zeolite beta may have a mesopore volume of greater than or equal to 0.5 mL/g, such as greater than or equal to 0.6 mL/g, or greater than or equal to 0.7 mL/g. In embodiments, the zeolite beta may have a mesopore volume of from 0.5 mL/g to 2.0 mL/g, such as from 0.5 mL/g to 1.5 mL/g, from 0.5 mL/g to 1.25 mL/g, from 0.75 mL/g to 2.0 mL/g, from 0.75 mL/g to 1.5 mL/g, or from 0.75 mL/g to 1.25 mL/g. The mesopore volume is determined using BJH analysis.

In embodiments, the zeolite beta may have a micropore volume of greater than or equal to 0.1 mL/g. In embodiments, the zeolite beta may have a micropore volume of from 0.1 mL/g to 1.0 mL/g, such as from 0.1 mL/g to 0.9 mL/g, from 0.1 mL/g to 0.5 mL/g, or from 0.1 mL/g to 0.2 mL/g. The micropore volume is determined using BJH analysis.

In embodiments, the zeolite beta may have an average pore size of greater than or equal to 3 nm, greater than or equal to 4 nm, greater than or equal to 5 nm, greater than or equal to 6 nm, greater than or equal to 7 nm, or even greater than or equal to 8 nm, as determined by BET analysis. In embodiments, the catalyst may have an average pore size of from 3 nm to 20 nm, such as from 3 nm to 18 nm, from 3 nm to 15 nm, from 3 nm to 10 nm, from 4 nm to 20 nm, from 4 nm to 18 nm, from 4 nm to 15 nm, from 4 nm to 10 nm, from 5 nm to 20 nm, from 5 nm to 18 nm, from 5 nm to 15 nm, from 5 nm to 10 nm, from 6 nm to 20 nm, from 6 nm to 18 nm, from 6 nm to 15 nm, or from 6 nm to 10 nm. The average pore size is determined using BJH analysis.

In embodiments, the Y zeolite is a combination of micro and mesopores leading to a hierarchical zeolite structure. In embodiments this hierarchical zeolite Y has preferred performance properties over Y zeolites without hierarchical structure.

In embodiments, the hierarchical zeolite Y may comprise a molar ratio of silica to alumina of from 5:1 to 100:1, such as from 5:1 to 90:1, from 5:1 to 80:1, from 5:1 to 70:1 or from 5:1 to 60:1.

In embodiments, the hierarchical zeolite Y may have a particle size from 30 nm to 800 nm, such as from 30 nm to 700 nm, 30 nm to 600 nm, 40 nm to 500 nm.

In embodiments, the hierarchical zeolite Y may have a surface area of greater than or equal to 400 cm²/g, such as greater than or equal to 450 cm²/g, or greater than or equal to 500 cm²/g. In embodiments, the zeolite beta may have a surface of from 400 cm²/g to 700 cm²/g, such as from 400 cm²/g to 600 cm²/g, from 400 cm²/g to 550 cm²/g, from 450 cm²/g to 700 cm²/g, from 450 cm²/g to 650 cm²/g, from 450 cm²/g to 600 cm²/g, from 450 cm²/g to 550 cm²/g, from 500 cm²/g to 700 cm²/g, from 500 cm²/g to 650 cm²/g, from 500 cm²/g to 600 cm²/g, or from 500 cm²/g to 550 cm²/g. The surface area is determined using Brunauer-Emmett-Teller (BET) analysis.

In embodiments, the hierarchical zeolite Y may have a mesopore volume of greater than or equal to 0.5 mL/g, such as greater than or equal to 0.6 mL/g, or greater than or equal to 0.7 mL/g. In embodiments, the zeolite beta may have a mesopore volume of from 0.5 mL/g to 2.0 mL/g, such as from 0.5 mL/g to 1.5 mL/g, from 0.5 mL/g to 1.25 mL/g, from 0.75 mL/g to 2.0 mL/g, from 0.75 mL/g to 1.5 mL/g, or from 0.75 mL/g to 1.25 mL/g. The mesopore volume is determined using BJH analysis.

In embodiments, the hierarchical zeolite Y may have a micropore volume of greater than or equal to 0.1 mL/g. In embodiments, the zeolite beta may have a micropore volume of from 0.1 mL/g to 1.0 mL/g, such as from 0.1 mL/g to 0.9 mL/g, from 0.1 mL/g to 0.5 mL/g, or from 0.1 mL/g to 0.2 mL/g. The micropore volume is determined using BJH analysis.

In embodiments, the hierarchical zeolite Y may have an average pore size of greater than or equal to 3 nm, greater than or equal to 4 nm, greater than or equal to 5 nm, greater than or equal to 6 nm, greater than or equal to 7 nm, or even greater than or equal to 8 nm, as determined by BET analysis. In embodiments, the catalyst may have an average pore size of from 3 nm to 20 nm, such as from 3 nm to 18 nm, from 3 nm to 15 nm, from 3 nm to 10 nm, from 4 nm to 20 nm, from 4 nm to 18 nm, from 4 nm to 15 nm, from 4 nm to 10 nm, from 5 nm to 20 nm, from 5 nm to 18 nm, from 5 nm to 15 nm, from 5 nm to 10 nm, from 6 nm to 20 nm, from 6 nm to 18 nm, from 6 nm to 15 nm, or from 6 nm to 10 nm. The average pore size is determined using BJH analysis.

In embodiments, the catalyst may comprise from 1 wt. % to 60 wt. % zeolite beta and hierarchical zeolite Y, based on the total weight of the catalyst. For instance, in embodiments the catalyst may comprise from 1 wt. % to 50 wt. %, from 1 wt. % to 40 wt. %, from 1 wt. % to 30 wt. %, from 5 wt. % to 60 wt. %, from 5 wt. % to 50 wt. %, from 5 wt. % to 40 wt. %, from 5 wt. % to 30 wt. %, from 10 wt. % to 60 wt. %, from 10 wt. % to 50 wt. %, from 10 wt. % to 40 wt. %, or from 10 wt. % to 30 wt. % zeolite beta and hierarchical zeolite Y.

In embodiments where the catalyst comprises the zeolite beta and the hierarchical zeolite Y, the catalyst may comprise a weight ratio of the zeolite beta to the hierarchical zeolite Y of from 1:5 to 5:1, such as from 1:5 to 2:1, from 1:5 to 1:1, or from 1:1 to 5:1.

In embodiments, the catalyst may comprise from 2 wt. % to 50 wt. % zeolite beta, based on the total weight of the catalyst. For instance, in embodiments the catalyst may comprise from 2 wt. % to 40 wt. %, from 2 wt. % to 30 wt. %, from 2 wt. % to 20 wt. %, from 5 wt. % to 50 wt. %, from 5 wt. % to 40 wt. %, from 5 wt. % to 30 wt. %, from 5 wt. % to 20 wt. %, from 10 wt. % to 50 wt. %, from 10 wt. % to 40 wt. %, from 10 wt. % to 30 wt. %, or from 10 wt. % to 20 wt. % zeolite beta.

In embodiments, the catalyst may comprise from 2 wt. % to 50 wt. % hierarchical zeolite Y, based on the total weight of the catalyst. For instance, in embodiments the catalyst may comprise from 2 wt. % to 40 wt. %, from 2 wt. % to 30 wt. %, from 2 wt. % to 20 wt. %, from 5 wt. % to 50 wt. %, from 5 wt. % to 40 wt. %, from 5 wt. % to 30 wt. %, from 5 wt. % to 20 wt. %, from 10 wt. % to 50 wt. %, from 10 wt. % to 40 wt. %, from 10 wt. % to 30 wt. %, or from 10 wt. % to 20 wt. % hierarchical zeolite Y.

According to one or more embodiments, the zeolite beta presently disclosed may be incorporated into a catalyst. The catalyst may be utilized as a hydrocracking catalyst in the pretreatment of heavy oils, as described subsequently in detail. As such, the catalysts which includes the zeolite beta may be referred to herein as a “hydrocracking catalyst.” However, it should be understood that, while the hydrocracking catalysts are described in the context of pretreatment (for example, hydrotreatment) of a heavy oil, the hydrocracking catalysts described herein may be useful for other catalytic reactions for the production of other petrochemical product.

In embodiments, the catalyst may comprise a hierarchical zeolite Y. Without intending to be bound by any particular theory, it is believed that the addition of a hierarchical zeolite Y in addition to the zeolite beta may provide additional hydrocracking ability to the catalyst derived therefrom, compared to catalysts that do not include hierarchical zeolite Y.

The catalyst comprises one or more metals, one or more metal oxides, or combinations thereof, chosen from tungsten atoms, molybdenum atoms, nickel atoms, tungsten oxide, molybdenum oxide, nickel oxide, or combinations thereof.

As used throughout this disclosure, “support material” may comprise nano-sized, mesoporous zeolites, metal oxides, and alumina. While metal catalyst materials may include metal oxides, it should be appreciated that the metal catalyst materials are distinct from the metal oxide support material of the catalyst which may, in some embodiments, be alumina. In some embodiments, support material is used as a binder, a binder paste, or an extrudable paste.

In one or more embodiments, the catalyst may comprise from 10 wt. % to 30 wt. % of the support material. The support material may comprise one or more inorganic oxides. The one or more inorganic oxides may act as a granulating agent or a binder. Exemplary inorganic oxides include, but are not limited to, alumina, silica, titania, silica-alumina, alumina-titania, alumina-zirconia, alumina-boria, phosphorus-alumina, silica-alumina-boria, phosphorus-alumina-boria, phosphorus-alumina-silica, silica-alumina-titania, and silica-alumina-zirconia. In some embodiments, the support material may comprise alumina, silica-alumina, or both. In various embodiments, the catalyst may comprise at least 10 wt. % of the support material and less than or equal to 30 wt. %, less than or equal to 25 wt. %, less than or equal to 20 wt. %, less than or equal to 15 wt. %, or even 10 wt. % of the support material. In some other embodiments, the catalyst may comprise less than or equal to 30 wt. % of the support material and at least 25 wt. %, at least 20 wt. %, or even at least 15 wt. % support material. It should be understood that the amount of the support material of the catalyst may be in a range formed from any one of the lower bounds for such amounts of the support material described herein to any one of the upper bounds for such amounts of the support material described herein.

In embodiments, the catalyst may comprise a from 20 wt. % to 80 wt. % Al₂O₃. For instance, in embodiments the catalyst may comprise from 20 wt. % to 60 wt. %, from 20 wt. % to 40 wt. %, from 30 wt. % to 60 wt. %, or from 30 wt. % to 40 wt. % Al₂O₃.

In embodiments, the catalyst may comprise from 1 wt. % to 10 wt. % nickel, based on the total weight of the catalyst. For instance, in embodiments, the catalyst may comprise from 1 wt. % to 8 wt. %, from 1 wt. % to 7 wt. %, from 1 wt. % to 6 wt. %, from 1 wt. % to 5 wt. %, from 1 wt. % to 4 wt. %, from 1 wt. % to 3 wt. %, or from 1 wt. % to 2 wt. % nickel. The nickel may be in any oxidation state, such as −1, 0, +2, +3, or +4. The amount of nickel present in the catalyst may be determined using elemental analysis, such as Inductively Coupled Plasma Spectroscopy (ICP).

In embodiments, the catalyst may comprise from 1 wt. % to 20 wt. % molybdenum, based on the total weight of the catalyst. For instance, in embodiments, the catalyst may comprise from 1 wt. % to 15 wt. %, from 1 wt. % to 10 wt. %, from 1 wt. % to 5 wt. %, or from 1 wt. % to 2 wt. % molybdenum. The molybdenum may be in any oxidation state, such as 0, ±2, ±3, ±4, ±5, or ±6. The amount of molybdenum present in the catalyst may be determined using elemental analysis, such as Inductively Coupled Plasma Spectroscopy (ICP).

In embodiments, the catalyst may comprise from 1 wt. % to 30 wt. % tungsten, based on the total weight of the catalyst. For instance, in embodiments, the catalyst may comprise from 1 wt. % to 25 wt. %, from 1 wt. % to 20 wt. %, from 1 wt. % to 15 wt. %, from 1 wt. % to 10 wt. %, from 1 wt. % to 5 wt. %, or from 1 wt. % to 2 wt. % tungsten, from 5 wt. % to 30 wt. %, from 5 wt. % to 25 wt. %, from 5 wt. % to 20 wt. %, from 5 wt. % to 15 wt. %, from 5 wt. % to 10 wt. %, from 10 wt. % to 30 wt. %, from 10 wt. % to 25 wt. %, from 10 wt. % to 20 wt. %, from 10 wt. % to 15 wt. %, from 15 wt. % to 30 wt. %, from 15 wt. % to 25 wt. %, from 15 wt. % to 20 wt. %, from 20 wt. % to 30 wt. %, or from 20 wt. % to 25 wt. % tungsten. The tungsten may be in any oxidation state, such as +2, +3, +4, +5, or +6. The amount of tungsten present in the catalyst may be determined using elemental analysis, such as Inductively Coupled Plasma Spectroscopy (ICP).

In embodiments, the catalyst may have a surface area of greater than or equal to 250 cm²/g or greater than or equal to 300 cm²/g, as determined by BET analysis. In embodiments, the catalyst may have a surface area of from 250 cm²/g to 450 cm²/g, such as from 250 cm²/g to 400 cm²/g, from 250 cm²/g to 350 cm²/g, from 250 cm²/g to 325 cm²/g, from 290 cm²/g to 450 cm²/g, from 290 cm²/g to 400 cm²/g, from 290 cm²/g to 350 cm²/g, or from 290 cm²/g to 325 cm²/g.

In embodiments, the catalyst may have a mesopore volume of greater than or equal to 0.3 mL/g, or greater than or equal to 0.4 mL/g. In embodiments, the catalyst may have a mesopore volume of from 0.4 mL/g to 1.1 mL/g, such as from 0.4 mL/g to 0.9 mL/g, from 0.4 mL/g to 0.8 mL/g, from 0.4 mL/g to 0.7 mL/g, from 0.5 mL/g to 1.1 mL/g, such as from 0.5 mL/g to 0.9 mL/g, from 0.5 mL/g to 0.8 mL/g, or from 0.5 mL/g to 0.7 mL/g. The mesopore volume is determined using BJH analysis.

In embodiments, the catalyst may have an average pore size of greater than or equal to 3 nm, greater than or equal to 4 nm, greater than or equal to 5 nm, greater than or equal to 6 nm, greater than or equal to 7 nm, or even greater than or equal to 8 nm. In embodiments, the catalyst may have an average pore size of from 3 nm to 15 nm, such as from 3 nm to 12 nm, from 3 nm to 10 nm, from 3 nm to 9 nm, from 4 nm to 15 nm, from 4 nm to 12 nm, from 4 nm to 10 nm, from 4 nm to 9 nm, from 5 nm to 15 nm, from 5 nm to 12 nm, from 5 nm to 10 nm, from 5 nm to 9 nm, from 6 nm to 15 nm, from 6 nm to 12 nm, from 6 nm to 10 nm, or from 6 nm to 9 nm. The average pore size is determined using BJH analysis.

The catalyst disclosed herein may be made by various methods. According to one or more embodiments, a catalyst may comprise the zeolite beta and the hierarchical zeolite Y.

In embodiments, the catalyst may be made by a method comprising: forming a composite comprising the hierarchical zeolite Y and the zeolite beta; extruding the composite to form a plurality of extrudates; and heating the extrudates.

### Forming a Composite

In embodiments, prior to the forming of the composite, water may be added to the zeolite beta at a weight ratio of water to zeolite beta of 0.5 to 2. For instance, in embodiments of the water addition step, the weight ratio of water to zeolite beta may be from 0.5 to 1.8, from 0.5 to 1.5, from 0.5 to 1.2, from 0.6 to 1.8, from 0.6 to 1.5, from 0.6 to 1.2, from 0.7 to 1.8, from 0.7 to 1.5, or from 0.7 to 1.2.

In embodiments, forming the composite may comprise mixing the hierarchical zeolite Y and the zeolite beta to form a zeolite mixture, the weight ratio of hierarchical zeolite Y to zeolite beta may be from 0.2 to 5. For instance, in embodiments, the weight ratio of hierarchical zeolite Y to zeolite beta may be from 0.2 to 4, from 0.2 to 3, 0.2 to 2, from 0.4 to 4, from 0.4 to 3, from 0.4 to 2, from 0.6 to 4, from 0.6 to 3, from 0.6 to 2, from 1 to 4, or from 1 to 3, from 1 to 2.

In embodiments, the zeolite mixture of hierarchical zeolite Y and zeolite beta may be heated at a temperature from 100° C. to 200° C. for a duration from 4 to 8 hours.

In embodiments, the zeolite mixture of hierarchical zeolite Y and zeolite beta may be hydrothermally treated at a temperature from 500° C. to 550° C. for a duration of 1 to 4 hours.

In embodiments, the forming of the composite comprises mixing the zeolite beta and the hierarchical zeolite Y to form a zeolite mixture, combining the zeolite mixture and support material.

In embodiments, the forming of the composite comprises mixing the zeolite beta and the hierarchical zeolite Y to form a zeolite mixture, combining the zeolite mixture, the support material, and one or more metals, one or more metal oxides, or combinations thereof, chosen from tungsten atoms, molybdenum atoms, nickel atoms, tungsten oxide, molybdenum oxide, nickel oxide, or combinations thereof.

### Extruding

In embodiments, the composite is extruded to form a plurality of extrudates.

### Heating

In embodiments, heating of the extrudates further comprise drying and calcinating at a temperature greater than or equal to 500° C. for a duration of at least 4 hours.

In embodiments, the method comprises, after the heating of the extrudates, contacting the extrudates to a metal solution comprising one or more metals, one or more metal oxides, or combinations thereof, chosen from tungsten atoms, molybdenum atoms, nickel atoms, tungsten oxide, molybdenum oxide, nickel oxide, or combinations thereof.

In embodiments, hierarchical zeolite Y may be synthesized with a starting material. In embodiments, the starting material may comprise silica and alumina. In embodiments, the starting material may have a molar ratio of silica to alumina less than or equal to 30. In embodiments, the starting material may have a molar ratio of silica to alumina greater than 30.

In embodiments, hierarchical zeolite Y may be synthesized with starting material CBV-100.

In embodiments, hierarchical zeolite Y may be synthesized with starting material CBV-720.

In embodiments, hierarchical zeolite Y may be synthesized with starting material CBV-760.

In embodiments, zeolite beta may be synthesized based on the methods disclosed in U.S. Pat. No. 11,148,124, which is incorporated by reference in this disclosure in its entirety.

In embodiments, the volume of mesopores may be greater than or equal to 35% of a total pore volume of the zeolite beta. The mesopore volume to total pore volume embodiment of zeolite beta which exceeds 35% may be mesoporous zeolite beta. For instance, in embodiments, the volume of the mesopores of the total pore volume of the zeolite beta may be from 35% to 40%, from 40% to 45%, from 45% to 50%, from 50% to 55%, from 55% to 60%, or from 65% to 70%.

In embodiments, the volume of mesopores may be greater than or equal to 40% of a total pore volume of the zeolite beta. The mesopore volume to total pore volume embodiment of zeolite beta which exceeds 40% may be mesoporous zeolite beta.

In embodiments, the volume of mesopores may be greater than or equal to 45% of a total pore volume of the zeolite beta. The mesopore volume to total pore volume embodiment of zeolite beta which exceeds 45% may be mesoporous zeolite beta.

In embodiments, the volume of mesopores may be greater than or equal to 50% of a total pore volume of the zeolite beta. The mesopore volume to total pore volume embodiment of zeolite beta which exceeds 50% may be mesoporous zeolite beta.

In embodiments, the volume of mesopores may be greater than or equal to 55% of a total pore volume of the zeolite beta. The mesopore volume to total pore volume embodiment of zeolite beta which exceeds 55% may be mesoporous zeolite beta.

In embodiments, the volume of mesopores may be greater than or equal to 60% of a total pore volume of the zeolite beta. The mesopore volume to total pore volume embodiment of zeolite beta which exceeds 60% may be mesoporous zeolite beta.

In embodiments, the volume of mesopores may be greater than or equal to 65% of a total pore volume of the zeolite beta. The mesopore volume to total pore volume embodiment of zeolite beta which exceeds 65% may be mesoporous zeolite beta.

In embodiments, the volume of mesopores may be greater than or equal to 70% of a total pore volume of the zeolite beta. The mesopore volume to total pore volume embodiment of zeolite beta which exceeds 70% may be mesoporous zeolite beta.

An embodiment described in examples herein provides a method for forming a composite of the zeolite beta and the hierarchical zeolite Y. The method includes a synthesizing of the zeolite beta, forming a slurry of the zeolite beta, and mixing hierarchical zeolite Y with the slurry to form a zeolite mixture. The mixture is dried and an extrudable paste is formed. The extrudable paste is extruded to form extrudates, which are calcined to form calcined extrudates.

In an aspect, a metal source is mixed with the dried composite while forming the extrudable paste. In an aspect, the metal source includes molybdenum. In an aspect, the metal source includes molybdenum oxide (MoO3). In an aspect, the metal source includes nickel. In an aspect, the metal source includes nickel nitrate.

In an aspect, the calcined extrudates are impregnated with a metal. In an aspect, the metal includes tungsten. In an aspect, the metal includes nickel.

In an aspect, impregnating the calcined extrudates with the metal includes soaking the calcined extrudates in a solution including the metal to form ion exchanged extrudates, drying the ion exchanged extrudates, and calcining the ion exchanged extrudates. In an aspect, the solution including the metal includes ammonium metatungstate. In an aspect, solution including the metal includes nickel nitrate hexahydrate.

Another embodiment described in examples herein provides a method for directly hydroprocessing a crude oil to form petrochemicals. The method includes flowing a feedstock including at least a portion of the crude oil into a hydroprocessing unit, and hydroprocessing the feedstock using a catalyst including a composite of the zeolite beta and hierarchical zeolite Y to form a product stream.

In an aspect, the composite of the zeolite beta and hierarchical zeolite Y, is formed by method that includes synthesizing the zeolite beta, forming a slurry of the zeolite beta, and mixing hierarchical zeolite Y with the slurry to form a zeolite mixture. The zeolite mixture is dried and an extrudable paste is formed. The extrudable paste may be extruded to form extrudates, which are calcined to form calcined extrudates.

In an aspect, forming the extrudable paste includes incorporating molybdenum and nickel. In an aspect, the calcined extrudates are impregnated with nickel and tungsten.

In embodiments, the zeolite beta may be formed by treating an initial zeolite beta. In embodiments, the initial zeolite beta may be formed according to the methods disclosed in U.S. Pat. No. 11,148,124, which is incorporated by reference in this disclosure in its entirety. The method of forming the zeolite beta may comprise contacting the initial zeolite beta with a quaternary ammonium salt to form an initial mixture. In embodiments, the initial mixture may be heated to a temperature greater than or equal to 150° C. for a duration of at least 10 hours to form a colloid. In embodiments, the colloid may be rinsed with de-ionized water. In embodiments, the rinsed colloid may be dried at a temperature greater than or equal to 110° C. for a duration of at least 12 hours to form a zeolite product. In embodiments, the zeolite product is dried at a temperature greater than or equal to 550° C. for a duration of at least 4 hours to form the zeolite beta.

The catalyst disclosed herein may be used in various processes for upgrading heavy oil. References will now be made in greater detail to various embodiments of the catalysts and methods of use. The catalysts described herein, according to some embodiments, may be suitable for utilizing in hydrocracking reactions. However, it should be understood that the presently disclosed catalyst may be utilized for other reaction types and/or mechanisms, and their use is not limited herein.

In embodiments, the catalysts as described herein may be used in methods of cracking hydrocarbon feed streams.

In embodiments, a process for upgrading heavy oil may comprise contacting the heavy oil with a catalyst, wherein the contacting hydrocracks the heavy oil to produce an updated product stream.

In embodiments, the hydrocarbon feed stream may be a crude oil.

In embodiments, the hydrocarbon feed stream may be hydrotreated before the contacting.

In embodiments, the hydrocarbon feed stream may comprise at least 5,000 parts per million by weight (ppmw), at least 10,000 ppmw, or even at least 15,000 ppmw sulfur, based on the total weight of the hydrocarbon feed stream. In embodiments, the hydrocarbon feed stream may comprise of from 5,000 ppmw to 40,000 ppmw sulfur, such as from 5,000 ppmw to 30,000 ppmw, from 5,000 ppmw to 25,000 ppmw, from 5,000 ppmw to 20,000 ppmw, from 10,000 ppmw to 40,000 ppmw, from 10,000 ppmw to 30,000 ppmw, from 10,000 ppmw to 25,000 ppmw, or from 10,000 ppmw to 20,000 ppmw sulfur.

In embodiments, the hydrocarbon feed stream may comprise at least 500 ppmw, at least 1,000 ppmw, or even at least 1,200 ppmw nitrogen, based on the total weight of the hydrocarbon feed stream. In embodiments, the hydrocarbon feed stream may comprise of from 500 ppmw to 4,000 ppmw nitrogen, such as from 500 ppmw to 3,000 ppmw, from 500 ppmw to 2,500 ppmw, from 500 ppmw to 2,000 ppmw, from 1,000 ppmw to 4,000 ppmw, from 1,000 ppmw to 3,000 ppmw, from 1,000 ppmw to 2,500 ppmw, from 1,000 ppmw to 2,000 ppmw, or from 1,000 ppmw to 1,500 ppmw nitrogen.

In embodiments, at least 50 wt. %, at least 55 wt. %, at least 60 wt. %, at least 65 wt. % or even at least 70 wt. % of the hydrocarbon feed stream may have a boiling point of greater than 500° C.

In embodiments, at least 10 wt. %, at least 15 wt. %, or at least 20 wt. % of the hydrocarbon feed stream may have a boiling point of greater than or equal to 1,000° C.

In embodiments, the product effluent may comprise greater than or equal to 40 wt. % naphtha based on the total weight of the product effluent. For instance, the product effluent may comprise greater than or equal to 45 wt. %, greater than or equal to 50 wt. %, greater than or equal to 55 wt. %, greater than or equal to 60 wt. %, or even greater than or equal to 65 wt. % naphtha. In embodiments, the product effluent may comprise of from 40 wt. % to 80 wt. % naphtha, such as from 40 wt. % to 70 wt. %, from 50 wt. % to 80 wt. %, from 50 wt. % to 70 wt. %, from 60 wt. % to 80 wt. %, from 60 wt. % to 70 wt. %, or from 65 wt. % to 70 wt. % naphtha.

Without intending to be bound by any particular theory, it is believed that the zeolites and catalysts described herein may be used to crack a hydrocarbon feed stream and produce a product effluent having a greater amount of naphtha compared to methods using conventional catalysts.

A first aspect of the present disclosure is directed to a catalyst, the catalyst comprising zeolite beta and hierarchical zeolite Y wherein the zeolite beta comprises a plurality of micropores having a pore size of less than 2 nm and a plurality of mesopores having a pore size of greater than or equal to 2 nm to less than or equal to 50 nm, a volume of mesopores is greater than or equal to 35% of a total pore volume of the zeolite beta; and an average particle size of the zeolite beta is less than or equal to 100 nm.

A second aspect of the present disclosure may include the first aspect, wherein a weight ratio of the zeolite beta and the hierarchical zeolite Y is from 0.2 to 5.

A third aspect of the present disclosure may include the first or the second aspect, wherein the catalyst further comprises a support material.

A fourth aspect of the present disclosure may include any one of the first through third aspects, wherein the catalyst comprises one or more metals, one or more metal oxides, or combinations thereof, chosen from tungsten atoms, molybdenum atoms, nickel atoms, tungsten oxide, molybdenum oxide, nickel oxide, or combinations thereof.

A fifth aspect of the present disclosure may include any one of the first through fourth aspects wherein the catalyst comprises from 2 wt. % to 50 wt. % of the zeolite beta, from 2 wt. % to 50 wt. % of the hierarchical zeolite Y, from 4 wt. % to 6 wt. % NiO; and from 20 wt. % to 80 wt. % Al₂O₃.

A sixth aspect of the present disclosure may include any one of the first through fifth aspect wherein the catalyst comprises from 10 wt. % to 60 wt. % of the zeolite beta and the hierarchical zeolite Y, from 4 wt. % to 6 wt. % NiO; and from 20 wt. % to 80 wt. % Al₂O₃.

A seventh aspect of the present disclosure may include any one of the first through sixth aspect wherein the catalyst comprises from 20 wt. % to 26 wt. % WO₃.

An eighth aspect of the present disclosure may include any one of the first through seventh aspects, wherein the catalyst comprises 14 wt. % to 16 wt. % MoO₃.

A ninth aspect of the present disclosure may include any one of the first through eighth aspects, wherein the hierarchical zeolite Y has an average silica to alumina molar ratio of less than or equal to 80.

A tenth aspect of the present disclosure is directed to a method for producing a catalyst, the method may comprise forming a composite comprising hierarchical zeolite Y and zeolite beta, extruding the composite to form a plurality of extrudates, and heating the extrudates, wherein the zeolite beta comprises a plurality of micropores having a pore size of greater than or equal to 2 nm to less than or equal to 50 nm, a volume of mesopores is greater than or equal to 35% of a total pore volume of the zeolite beta, and an average particle size of the zeolite beta is less than or equal to 100 nm.

An eleventh aspect of the present disclosure may include the tenth aspect, the forming of a composite further comprising, prior to the forming, a water addition step, wherein water is added to the zeolite beta at a weight ratio of water to zeolite beta of 0.5 to 2.

A twelfth aspect of the present disclosure may include the tenth or eleventh aspects, the heating of the extrudates further comprising drying at 100° C. to 200° C. for 4 to 8 hours.

A thirteenth aspect of the present disclosure may include any one of the tenth through twelfth aspects, the heating of the extrudates further comprising hydrothermally treating under 0.1 MPa steam at 500° C. to 550° C. for 1 to 4 hours.

A fourteenth aspect of the present disclosure may include any one of the tenth through thirteenth aspects, wherein the composite further comprises MoO₃, Ni(NO₃)₂, and support material;

A fifteenth aspect of the present disclosure may include any one of the tenth through fourteenth aspects, wherein heating of the extrudates further comprises drying and calcinating at a temperature greater than or equal to 500° C. for a duration of at least 4 hours.

A sixteenth aspect of the present disclosure may include any one of the tenth through fifteenth aspects wherein the composite further comprises a support material, the heating of the extrudates further comprises drying and calcinating at a temperature greater than or equal to 500° C. for a duration of at least 4 hours, and the method further comprises, after the heating, contacting the extrudate to a metal solution comprising one or more metals, one or more metal oxides, or combinations thereof, chosen from tungsten atoms, molybdenum atoms, nickel atoms, tungsten oxide, molybdenum oxide, nickel oxide, or combinations thereof.

A seventeenth aspect of the present disclosure may include any one of the tenth through sixteenth aspects, wherein the metal solution comprises nickel nitrate hexahydrate.

An eighteenth aspect of the present disclosure may include any one of the tenth through eighteenth aspects, wherein the metal solution comprises ammonium metatungstate.

A nineteenth aspect of the present disclosure is directed to a process for upgrading a heavy oil, the process comprising contacting the heavy oil with a catalyst, wherein the contacting hydrocracks the heavy oil to produce an updated product stream, the catalyst comprises zeolite beta and hierarchical zeolite Y, wherein the zeolite beta comprises a plurality of micropores having a pore size of less than 2 nm and a plurality of mesopores having a pore size of greater than or equal to 2 nm to less than or equal to 50 nm, a volume of mesopores is greater than or equal to 35% of a total pore volume of the zeolite beta and an average particle size of the zeolite beta is less than or equal to 100 nm.

A twentieth aspect of the present disclosure may include the nineteenth aspect, wherein the heavy oil and catalyst are contacted in a reactor, and a temperature of the reactor during the contacting is greater than or equal to 335° C.

A twenty-first aspect of the present disclosure may include the nineteenth or twentieth aspect, wherein the heavy oil is a crude oil comprising an API gravity of 25 to 30.

A twenty-second aspect of the present disclosure may include any one of the nineteenth through twenty-first aspects, wherein the updated product stream comprises greater than or equal to 47 wt. % ethylene, propylene, and butene.

A twenty-third aspect of the present disclosure may include any one of the nineteenth through twenty-second aspects, wherein hydrogen consumption is less than 4.75 wt. %.

A twenty-fourth aspect of the present disclosure may include any one of the nineteenth through twenty-third aspects, wherein the updated product stream comprises a sulfur concentration less than or equal to 16.9 wppm

A twenty-fifth aspect of the present disclosure may include any one of the nineteenth through twenty-fourth aspects, wherein the updated product stream comprises a nitrogen concentration less than or equal to 3.7 wppm.

A twenty-sixth aspect of the present disclosure may include any one of the nineteenth through twenty-fifth aspects, wherein the updated product stream has a density less than or equal to 0.7999 g/ml.

### EXAMPLES

The various embodiments disclosed herein will be further clarified by the following examples. The examples are illustrative in nature, and should not be understood to limit the embodiments disclosed herein.

### Example 1—Making the Catalyst

In example 1, a catalyst was formed using a zeolite beta and hierarchical zeolite Y.

The zeolite beta of example 1 was synthesized from the same source of zeolite beta used in comparative example A, “NB-A”. A sequestered beaker was charged with 62.5 g 0.5 M NH₃·H₂O, further charged with 2.265 g cetyltrimethylammonium bromide (CTAB), and stirred for 10 minutes. The solution was then charged with 4.56 g of the zeolite beta of U.S. Pat. No. 11,148,124, NB-A, and mixed for an additional 20 minutes. The mixture was transferred to an autoclave. The mixture was heated in an oven at 150° C. for 10 hours. A colloid was formed at the end of the process. The colloid was removed from the autoclave oven and washed twice with a centrifuge. The washed solid product was then placed into an oven at 110° C. and dried overnight. The dry solid product was then calcinated at 550° C. for 4 hours. The zeolite beta formed in example 1 is “NB-1”,” in which the NB-1 zeolite beta was formed with increased mesoporous pore volume to total pore volume compared to the parent zeolite NB-A. The properties of NB-A and NB-1 are summarized in Table 1.

The hierarchical zeolite Y used in example 1, “MesoY-1,” was obtained by Rive technologies, product number RP128-84-03. The properties MesoY-1 are summarized in Table 1.

A support material binder was prepared by mixing 27.3 g Catapal alumina from Sasol with a diluted nitric acid solution. The nitric acid solution was prepared by mixing 3.22 mL of a concentrated nitric acid (67 wt. % to 69 wt. %) into 68.16 g of water. The binder was mixed to form a support material binder paste. Separate from the support material binder paste, a mixture was made from: 39.2 g MesoY-1, 18.5 g NB-1, 15 g MoO₃, 20 g Ni(NO₃)₂·H₂O, and 10.3 g Pural alumina from Sasol to form a zeolite mixture. The zeolite mixture comprising hierarchical zeolite Y and zeolite beta was thoroughly mixed.

The zeolite mixture comprising hierarchical zeolite Y and zeolite beta was then added to the support material binder paste to form an extrudable paste. Water was added to the zeolite mixture to attain a desired consistency to enhance extrusion properties. The desired consistency is a tacky agglomerate under light pressure. The extrudable paste of desired consistency was then extruded to make extrudates. The extrudates were dried at 110° C., and calcinated for 4 hours at 500° C.

Example 1 catalyst is composed of weight composition: 15 wt. % MoO₃, 5 wt. % NiO, 50 wt. % zeolite (30 wt. % hierarchical zeolite Y, 20 wt. % zeolite beta), 10 wt. % Pural Alumina, 20 wt. % Catapal Alumina.

### Comparative Example A—Making the Comparative Catalyst

The zeolite beta used in comparative example A, “NB-A,” was synthesized based on the methods disclosed in U.S. Pat. No. 11,148,124, the properties of NB-A are summarized in Table 1, and are identical to zeolite “Z-1” of U.S. Pat. No. 11,148,124. The hierarchical zeolite Y used in comparative example A, “MesoY-A,” was obtained by Rive technologies, product number RP128-54-30. The properties MesoY-A are summarized in Table 1.

A support material binder was prepared by mixing 27.3 g Catapal alumina from Sasol with a diluted nitric acid solution. The nitric acid solution was prepared by mixing 3.22 mL of a concentrated nitric acid (67 wt. % to 69 wt. %) into 68.16 g of water. Separate from the support material binder, a zeolite mixture was made from: 37.8 g MesoY-1, 20.3 g NB-1, 15 g MoO₃, 20 g Ni(NO₃)₂·H₂O, and 10.3 g Pural alumina from Sasol. The zeolite mixture comprising hierarchical zeolite Y and zeolite beta was thoroughly mixed.

The zeolite mixture comprising hierarchical zeolite Y and zeolite beta was then added to the support material binder to form an extrudable paste. Water was added to the desired consistency to attain a desired consistency to enhance extrusion properties. The desired consistency is a tacky agglomerate under light pressure. The extrudable paste of desired consistency was then extruded to make extrudates. The extrudates were dried at 110° C., and calcinated for 4 hours at 500° C.

Comparative Example A catalyst is composed of weight composition: 15 wt. % MoO₃, 5 wt. % NiO, 50 wt. % zeolite (30 wt. % hierarchical zeolite Y, 20 wt. % zeolite beta), 10 wt. % Pural Alumina, 20 wt. % Catapal Alumina.

### Example 2—Characterization of Example 1 and Comparative Example A

The main properties of the zeolites and catalysts from Example 1 and comparative example A were characterized by TEM, BET, XRD, and XRF, among other techniques, as described below. The hydrocracking performances were evaluated in high through-put reactors and an in-house pilot plant.

The particle sizes of the zeolites were measured by transmission electron microscopy (TEM).

The crystallinity and phase identity, e.g., zeolite beta versus zeolite Y, of the solid product was measured by powder X-ray diffraction (XRD) using a Rigaku Ultima IV multi-purpose diffractometer with a copper X-ray tube. The scanning range was set between 2° to 50° in 28 Bragg-angles with a step size of 0.04° and the total counting time of 1° per minute. The crystallinity percentage was calculated by PANalytical High Score Plus software through the comparison of the area under the most intense diffraction peak to that of patterns of the reference zeolite.

X-ray fluorescence (XRF) was used to measure the atomic composition of the catalyst. The Si and Al content were measured by the XRF (X-ray florescence), and then used to calculate the SiO₂/Al₂O₃ molar ratio.

Surface area and pore volume were measured using a physisorption analyzer (Autosorb IQ from Quantachrome Instruments). Nitrogen adsorption at 77 K is a commonly applied technique to determine various characteristics of porous materials. The amount of adsorbed nitrogen is measured as a function of the applied vapor pressure, which comprises the adsorption isotherm.

Characteristics that were derived from the nitrogen adsorption isotherm include total pore volume calculated by total nitrogen adsorbed and surface area. The most widely used procedure for the determination of the surface area of porous materials is the Brunauer-Emmett-Teller (BET) method. Brunauer-Emmett-Teller (BET) theory aims to explain the physical adsorption of gas molecules on a solid surface and serves as the basis for an important analysis technique for the measurement of the specific surface area of materials. In 1938, Stephen Brunauer, Paul Hugh Emmett, and Edward Teller published the first article about the BET theory in the Journal of the American Chemical Society. The BET theory applies to systems of multilayer adsorption and usually utilizes probing gases that do not chemically react with material surfaces as adsorbates to quantify specific surface area. Nitrogen is the most commonly employed gaseous adsorbate used for surface probing by BET methods.

For this reason, standard BET analysis is most often conducted at the boiling temperature of N₂ (77 K). Specific surface area is a scale-dependent property, with no single true value of specific surface area definable, and thus quantities of specific surface area determined through BET theory may depend on the adsorbate molecule utilized and its adsorption cross section. The BET surface area is calculated by constructing a BET plot using the relative pressure range up to 0.3. In this part of the isotherm a single layer (or monolayer) of nitrogen molecules is formed on the surface.

TABLE 1
The main properties of the zeolite beta and hierarchical zeolite Y.

| | Zeolite | | | |
|---|---|---|---|---|
| | Nano- | Nano- | | |
| | sized beta | sized beta | Hierarchical Y | Hierarchical Y |
| Example name | NB-A | NB-1 | MesoY-A | MesoY-1 |
| Particle sizes, | 30-60 | 30-60 | 500 | 500 |
| nm | | | | |
| XRD phase | Zeolite | Zeolite | Zeolite Y | Zeolite Y |
| | beta | beta | | |
| SiO2/Al2O3 | 50 | 30 | 30 | 7.5 |
| molar ratio | | | | |
| BET results | | | | |
| Specific | 555 | 652 | 841 | 814 |
| surface area, | | | | |
| m2/g | | | | |
| Pore volume, | 0.54 | 1.1 | 0.6 | 0.57 |
| ml/g | | | | |
| Mesopore | 0.19 | 0.9 | 0.34 | 0.3 |
| volume, ml/g | | | | |
| Mesopore to | 35% | 82% | 57% | 53% |
| total pore | | | | |
| volume, % | | | | |
| Average pore | 18 | 6.8 | 2.3 | 2.8 |
| size, nm | | | | |

TABLE 2
Catalyst properties.

| | | Comparative |
|---|---|---|
| | Example 1 | Example A |
| Surface area, m²/g | 380 | 355 |
| Total pore volume, | 0.55 | 0.47 |
| mL/g | | |
| Micropore volume, | 0.1 | 0.10 |
| mL/g | | |
| Mesopore volume, | 0.45 | 0.37 |
| mL/g | | |
| Pore size, nm | 4.7 | 5.3 |

### Processing Tests

The reaction performance with Arab light crude was evaluated in HTE high through-put reactor system. The catalyst of Comparative Example A and the catalyst of Example 1 properties are listed in Table 2. The test conditions are listed in Table 3, along with the results. The results showed the inventive catalysts had higher initial activity than the catalysts made using individual zeolites. As shown in Table 3, under the same conditions, the catalyst of example 1 with the composite of MesoY-1 and NB-1 has higher activity. As shown in Table 3, under the same conditions, the catalyst of example 1 has a product stream of greatly reduced heavy product fractions >350° C., lower product densities, lower iC4/nC4 ratio, and a reduced hydrogen consumption at reactor conditions at 335° C. Table 4 lists the iC4 and nC4 yields.

TABLE 3
Reaction performance comparison of catalysts.

| | | |
|---|---|---|
| Catalyst | Comparative Example A | Example 1 |

Reaction conditions

| | | | | | | |
|---|---|---|---|---|---|---|
| Temperature, ° C. | 335 | 345 | 360 | 335 | 345 | 360 |
| Pressure, bar | 150 | 150 | 150 | 150 | 150 | 150 |
| LHSV, h−1 | 1.5 | 1.5 | 1.5 | 1.5 | 1.5 | 1.5 |
| H2/oil ratio, v/v | 1200 | 1200 | 1200 | 1200 | 1200 | 1200 |

Product properties

| | | | | | | |
|---|---|---|---|---|---|---|
| Density at | 0.8252 | 0.804 | 0.78 | 0.7999 | 0.7672 | 0.735 |
| 15° C., g/ml | | | | | | |
| Nitrogen, wppm | 3.1 | 3.2 | 0 | 2.7 | 3.7 | 0 |
| Sulfur, wppm | 57.8 | 19.5 | 0 | 16.9 | 3.8 | 0 |

Product yield, wt %

| | | | | | | |
|---|---|---|---|---|---|---|
| H2 | 2.7 | 3.25 | 4.34 | 2.52 | 3.61 | 4.75 |
| consumption, | | | | | | |
| wt % | | | | | | |
| C1 | 0 | 0 | 0 | 0 | 0 | 0 |
| C2 | 0.13 | 0.24 | 0.57 | 0.1 | 0.26 | 0.63 |
| C3 | 2.18 | 3.58 | 6.95 | 1.44 | 3.24 | 7.17 |
| i-C4 | 9.1 | 13.11 | 20.36 | 5.38 | 11.52 | 19.35 |
| n-C4 | 2.79 | 4.22 | 7.22 | 1.99 | 4.18 | 7.94 |
| C1-C4 | 14.2 | 21.2 | 35.1 | 8.9 | 19.2 | 35.1 |
| C5-180° C. | 59.8 | 69.4 | 68.1 | 58.3 | 77.8 | 69.8 |
| naptha | | | | | | |
| products | | | | | | |
| 180-350° C. | 18 | 9.6 | 1.2 | 25 | 5.8 | 0.1 |
| >350° C. | 10.5 | 2.9 | 0.1 | 10 | 0.7 | 0 |

TABLE 4
Olefin production

Feed

| | |
|---|---|
| n•C₄H₁₀ | i•C₄H₁₀ |

| | |
|---|---|
| Yields | wt % |

| | | |
|---|---|---|
| H₂ | 1.09 | 1.26 |
| CH₄ | 24.57 | 27.38 |
| C₂H₂, ethylene | 0.64 | 0.73 |
| C₂H₄ | 38.42 | 16.55 |
| C₂H₆ | 3.89 | 0.61 |
| C₃H₄ | 0.94 | 2.82 |
| C₃H₆, propylene | 12.6 | 15.8 |
| C₃H₈ | 0.08 | 0.33 |
| C₄H₆ | 3.86 | 2.42 |
| C₄H₈, butane | 0.99 | 14.07 |
| C₄H₁₀ | 1.75 | 2.79 |
| C₅ Plus | 11.17 | 15.24 |
| TOTAL | 100 | 100 |
| ethylene + proplene + butene | 52.01 | 46.42 |
| E + P + B, olefin | | |

It will be apparent to persons of ordinary skill in the art that various modifications and variations can be made without departing from the scope disclosed herein. Since modifications, combinations, sub-combinations, and variations of the disclosed embodiments, which incorporate the spirit and substance disclosed herein, may occur to persons of ordinary skill in the art, the scope disclosed herein should be construed to include everything within the scope of the appended claims and their equivalents.

For the purposes of defining the present technology, the transitional phrase “consisting of” may be introduced in the claims as a closed preamble term limiting the scope of the claims to the recited components or steps and any naturally occurring impurities. For the purposes of defining the present technology, the transitional phrase “consisting essentially of” may be introduced in the claims to limit the scope of one or more claims to the recited elements, components, materials, or method steps as well as any non-recited elements, components, materials, or method steps that do not materially affect the novel characteristics of the claimed subject matter. The transitional phrases “consisting of” and “consisting essentially of” may be interpreted to be subsets of the open-ended transitional phrases, such as “comprising” and “including,” such that any use of an open ended phrase to introduce a recitation of a series of elements, components, materials, or steps should be interpreted to also disclose recitation of the series of elements, components, materials, or steps using the closed terms “consisting of” and “consisting essentially of.” For example, the recitation of a composition “comprising” components A, B, and C should be interpreted as also disclosing a composition “consisting of” components A, B, and C as well as a composition “consisting essentially of” components A, B, and C. Any quantitative value expressed in the present application may be considered to include open-ended embodiments consistent with the transitional phrases “comprising” or “including” as well as closed or partially closed embodiments consistent with the transitional phrases “consisting of” and “consisting essentially of.”

As used in the Specification and appended Claims, the singular forms “a”, “an”, and “the” include plural references unless the context clearly indicates otherwise. The verb “comprises” and its conjugated forms should be interpreted as referring to elements, components or steps in a non-exclusive manner. The referenced elements, components or steps may be present, utilized or combined with other elements, components or steps not expressly referenced.

It should be understood that any two quantitative values assigned to a property may constitute a range of that property, and all combinations of ranges formed from all stated quantitative values of a given property are contemplated in this disclosure. The subject matter disclosed herein has been described in detail and by reference to specific embodiments. It should be understood that any detailed description of a component or feature of an embodiment does not necessarily imply that the component or feature is essential to the particular embodiment or to any other embodiment. Further, it should be apparent to those skilled in the art that various modifications and variations can be made to the described embodiments without departing from the spirit and scope of the claimed subject matter.

What is claimed is:

1. A catalyst, the catalyst comprising:
zeolite beta; and
hierarchical zeolite Y;
wherein:
the zeolite beta comprises a plurality of micropores having a pore size of less than 2 nm and a plurality of mesopores having a pore size of greater than or equal to 2 nm to less than or equal to 50 nm;
a volume of mesopores is greater than or equal to 35% of a total pore volume of the zeolite beta; and
an average particle size of the zeolite beta is less than or equal to 100 nm.

2. The catalyst of claim 1, wherein a weight ratio of the zeolite beta and the hierarchical zeolite Y is from 0.2 to 5.

3. The catalyst of claim 1, wherein the catalyst further comprises a support material.

4. The catalyst of claim 1, wherein:
The catalyst comprises one or more metals, one or more metal oxides, or combinations thereof, chosen from tungsten atoms, molybdenum atoms, nickel atoms, tungsten oxide, molybdenum oxide, nickel oxide, or combinations thereof.

5. The catalyst of claim 1, wherein the catalyst comprises:
from 2 wt. % to 50 wt. % of the zeolite beta;
from 2 wt. % to 50 wt. % of the hierarchical zeolite Y;
from 4 wt. % to 6 wt. % NiO; and
from 20 wt. % to 80 wt. % Al₂O₃.

6. The catalyst of claim 1, wherein the catalyst comprises:
from 10 wt. % to 60 wt. % of the zeolite beta and the hierarchical zeolite Y;
from 4 wt. % to 6 wt. % NiO; and
from 20 wt. % to 80 wt. % Al₂O₃.

7. The catalyst of claim 1, wherein the catalyst comprises 20 wt. % to 26 wt. % WO₃.

8. The catalyst of claim 1, wherein the catalyst comprises 14 wt. % to 16 wt. % MoO₃.

9. The catalyst of claim 1, wherein the hierarchical zeolite Y has an average silica to alumina molar ratio of less than or equal to 80.

10. A method of making a catalyst comprising:
forming a composite comprising hierarchical zeolite Y and zeolite beta;
extruding the composite to form a plurality of extrudates; and
heating the extrudates;
wherein:
the zeolite beta comprises a plurality of micropores having a pore size of less than 2 nm and a plurality of mesopores having a pore size of greater than or equal to 2 nm to less than or equal to 50 nm;
a volume of mesopores is greater than or equal to 35% of a total pore volume of the zeolite beta; and
an average particle size of the zeolite beta is less than or equal to 100 nm.

11. The method of claim 10, further comprising, prior to the forming of the composite, adding water to the zeolite beta at a weight ratio of water to zeolite beta of 0.5 to 2.

12. The method of claim 10, wherein forming the composite comprises:
mixing the zeolite beta and the hierarchical zeolite Y to form a zeolite mixture; and
heating the zeolite mixture at a temperature from 100° C. to 200° C. for a duration from 4 to 8 hours, or
hydrothermally treating the zeolite mixture at a temperature from 500° C. to 550° C. for a duration from 1 to 4 hours.

13. The method of claim 10, wherein forming the composite comprises:
mixing the zeolite beta and the hierarchical zeolite Y to form a zeolite mixture; and
combing the zeolite mixture and a support material.

14. The method of claim 10, wherein forming the composite comprises:
mixing the zeolite beta and the hierarchical zeolite Y to form a zeolite mixture; and
combing the zeolite mixture, a support material, and one or more metals, one or more metal oxides, or combinations thereof, chosen from tungsten atoms, molybdenum atoms, nickel atoms, tungsten oxide, molybdenum oxide, nickel oxide, or combinations thereof.

15. The method of claim 10, wherein heating of the extrudates further comprises:
drying and calcinating at a temperature greater than or equal to 500° C. for a duration of at least 4 hours.

16. The method of claim 10, wherein the method further comprises, after the heating of the extrudates, contacting the extrudates to a metal solution comprising one or more metals, one or more metal oxides, or combinations thereof, chosen from tungsten atoms, molybdenum atoms, nickel atoms, tungsten oxide, molybdenum oxide, nickel oxide, or combinations thereof.

17. The method of claim 16, wherein the metal solution comprises nickel nitrate hexahydrate.

18. The method of claim 16, wherein the metal solution comprises ammonium metatungstate.

19. A process for upgrading a heavy oil, the process comprising:
contacting the heavy oil with a catalyst, wherein the contacting hydrocracks the heavy oil to produce an updated product stream;
the catalyst comprises zeolite beta, and
hierarchical zeolite Y;
wherein:
the zeolite beta comprises a plurality of micropores having a pore size of less than 2 nm and a plurality of mesopores having a pore size of greater than or equal to 2 nm to less than or equal to 50 nm;
a volume of mesopores is greater than or equal to 35% of a total pore volume of the zeolite beta; and
an average particle size of the zeolite beta is less than or equal to 100 nm.

20. The process of claim 19, wherein the heavy oil and catalyst are contacted in a reactor, and a temperature of the reactor during the contacting is greater than or equal to 335° C.

21. The process of claim 19, wherein the heavy oil is a crude oil comprising an API gravity of 25 to 30.

22. The process of claim 19, wherein the updated product stream comprises greater than 47 wt. % ethylene, propylene, and butene.

23. The process of claim 19, wherein hydrogen consumption is less than 4.75 wt. %.

24. The process of claim 19, wherein the updated product stream comprises a sulfur concentration less than or equal to 16.9 wppm.

25. The process of claim 19, wherein the updated product stream comprises a nitrogen concentration less than or equal to 3.7 wppm.

26. The process of claim 19, wherein the updated product stream has a density less than or equal to 0.7999 g/ml.
